(19) United States
(12) Patent Application Publication
(10) Pub. No.: US 2022/0238005 A1
(43) Pub. Date: Jul. 28, 2022

(54) DISASTER MANAGEMENT SYSTEM AND METHOD FOR MANAGING DISASTER INFOMRATION USING THE SYSTEM

(71) Applicant: ELECTRONICS AND TELECOMMUNICATIONS RESEARCH INSTITUTE, Daejeon (KR)

(72) Inventors: Sun Hwa LIM, Daejeon (KR); Sang Gi HONG, Daejeon (KR); Sang Hyun MO, Daejeon (KR); So Young PARK, Daejeon (KR); Kyo Hoon SON, Daejeon (KR); Kang Bok LEE, Daejeon (KR); Ji Hun JEON, Daejeon (KR)

(21) Appl. No.: 17/520,393

(22) Filed: Nov. 5, 2021

(30) Foreign Application Priority Data
Jan. 27, 2021 (KR) 10-2021-0011645

(51) Int. Cl. G08B 25/00; G08B 21/10; G08B 17/06

(52) U.S. Cl. CPC G08B 25/006; G08B 17/06; G08B 21/10

(57) ABSTRACT

Provided is a disaster management system including a plurality of fire receivers configured to receive fire data including sensing data and event data from a plurality of fire-fighting facilities and configure the fire data as fire data having different data structures and a disaster information management server configured to configure the fire data having different data structures received from the plurality of fire receivers as standardized standard data and transmit the configured standard data to an external server.

### CROSS-REFERENCE TO RELATED APPLICATION

This application claims priority under 35 U.S.C. §119 to Korean Patent Application No. 10-2021-0011645, filed on Jan. 27, 2021, the disclosure of which is incorporated herein by reference in its entirety.

### BACKGROUND

### 1. Technical Field

The present invention relates to a disaster management system and method for monitoring the state of a firefighting facility and the occurrence of a fire in real time.

### 2. Description of Related Art

Recently, research into a disaster management system that may detect an occurrence of a disaster situation such as a fire, earthquake at an early stage and provide a notification service to minimize damage to human life and properties has been actively conducted.

A fire disaster prevention system is one of disaster management systems. A fire disaster prevention system built in one building may include a plurality of fire fighting facilities and a plurality of fire receivers respectively connected to the plurality of fire fighting facilities.

Each fire-fighting facility detects an occurrence of a fire, transmits fire information related to the occurrence of the fire to a corresponding fire receiver, and each fire receiver transmits the fire information received from the fire-fighting facility connected thereto to a relevant organization. Here, the relevant organization may be a 119 general situation room or a fire station.

Meanwhile, when the fire receivers installed in a building are different types of fire receivers, the different types of fire receivers may convert fire information received from respective fire-fighting facilities into fire information having different data structures according to different communication protocols and transmit the converted fire information to relevant organization. In this case, the relevant organization collects fire information having different data structures, and thus, it is difficult to integratedly manage fire information received from different types of fire receivers.

In addition, the fire information transmitted to the relevant organization by the fire receivers in the related art includes information related to a location of the fire at an approximate level indicating which floor in the building a fire occurred. In order to quickly and efficiently respond to the fire when the fire report is received by the relevant organization, the fire receivers need to transmit an exact location of the fire to the relevant organization.

### SUMMARY

Accordingly, the present invention provides a disaster management system and method for converting data related to a fire collected from different types of fire receivers into standardized data, converting the converted standardized data to include an accurate fire occurrence location, and transmitting the data to a relevant organization.

In one general aspect, a disaster information management method of a disaster management system includes: configuring, by a plurality of different type fire receivers, fire data received from a plurality of fire-fighting facilities to have different data structures; configuring, by a disaster information management server, the fire data having different data structures received from the plurality of different fire receives, into standard data standardized to have a common data structure; and transmitting, by the disaster information management server, the standard data to an external server installed in a relevant organization.

In another general aspect, a disaster management system includes: a plurality of fire receivers configured to receive fire data including sensing data and event data from a plurality of fire-fighting facilities and configure the fire data as fire data having different data structures; and a disaster information management server configured to configure the fire data having different data structures received from the plurality of fire receivers as standardized standard data and transmit the configured standard data to an external server.

Other features and aspects will be apparent from the following detailed description, the drawings, and the claims.

### BRIEF DESCRIPTION OF THE DRAWINGS

FIG. 1 is a configuration diagram of a disaster management system according to an embodiment of the present invention.

FIG. 2 is a block diagram of fire-fighting facilities shown in FIG. 1.

FIG. 3 is a block diagram of a data receiving module shown in FIG. 1.

FIG. 4 is a diagram illustrating a data format of standard data converted from fire data received from different type fire receivers according to an embodiment of the present invention.

FIG. 5 is a block diagram of a data management module shown in FIG. 1

FIG. 6 is a diagram schematically illustrating a mapping table defining a mapping relationship between fire-fighting facilities and spatial information according to an embodiment of the present invention.

FIG. 7 is a diagram illustrating a data format of final standard data according to an embodiment of the present invention.

FIG. 8 is a flowchart illustrating a disaster information management method of a disaster management system according to an embodiment of the present invention.

### DETAILED DESCRIPTION OF EMBODIMENTS

In embodiments of the present invention disclosed in the detailed description, specific structural or functional descriptions are merely made for the purpose of describing embodiments of the present invention. Embodiments of the present invention may be embodied in various forms, and the present invention should not be construed as being limited to embodiments of the present invention disclosed in the detailed description.

Embodiments of the present invention are provided so that this disclosure will be thorough and complete, and will fully convey the concept of the present invention to one of ordinary skill in the art. Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention. Like reference numerals refer to like elements throughout.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In various embodiments of the disclosure, the meaning of ‘comprise’, ‘include’, or ‘have’ specifies a property, a region, a fixed number, a step, a process, an element and/or a component but does not exclude other properties, regions, fixed numbers, steps, processes, elements and/or components.

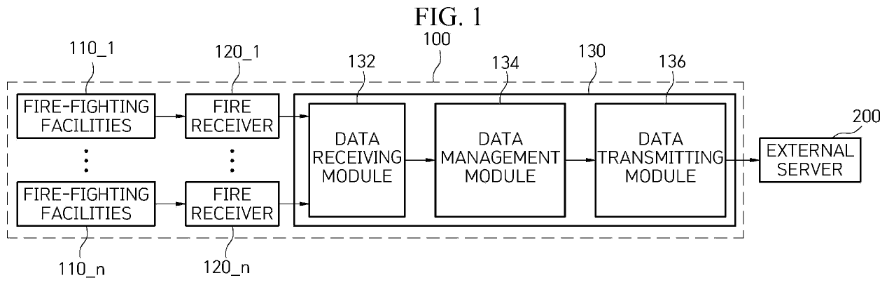

FIG. 1 is a configuration diagram schematically illustrating an overall configuration of a disaster management system according to an embodiment of the present invention.

Referring to FIG. 1, a disaster management system according to an embodiment of the present invention includes a plurality of fire-fighting facilities 110_1 to 110_n, a plurality of different type fire receivers 120_1 to 120_n, and a disaster information management server 130. The plurality of fire-fighting facilities 110_1 to 110_n, the plurality of different type fire receivers 120_1 to 120_n, and the disaster information management server 130 may be installed in the same space (e.g., a building).

Alternatively, the disaster information management server 130 may be installed in a different space. For example, the plurality of fire-fighting facilities 110_1 to 110_n and the plurality of different type fire receivers 120_1 to 120_n may be installed in the same building, and the disaster information management server 130 may be installed in a building located near or far from the building in which the components 110_1 to 110_n and 120_1˜120_n are installed.

The plurality of fire-fighting facilities 110_1 to 110_n are respectively connected to a plurality of different type fire receivers 120_1 to 120_n) by wire. When a fire occurs, each fire-fighting facility transmits a fire-related signal to the plurality of different type fire receivers 120_1 to 120_n.

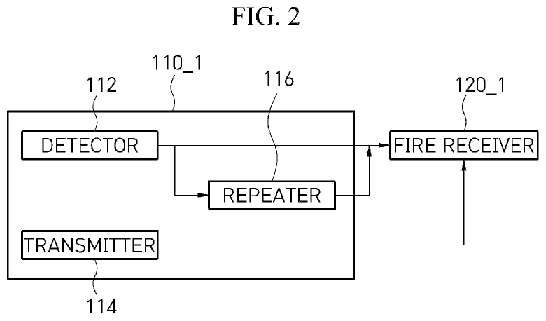

FIG. 2 is a block diagram of the fire-fighting facility shown in FIG. 1.

Referring to FIG. 2, the fire-fighting facility includes a detector 112, a transmitter 114, a repeater 116, and the like, as a fire detection facility.

The detector 112 automatically detects smoke, gas, heat or flame generated from a fire, and transmits sensing data corresponding to a detection result to the fire receiver 120_1 directly via wire or through the repeater 116. The detector 112 includes, for example, a heat detector, a smoke detector, a gas detector, and the like.

The transmitter 114 is a device that generates event data indicating an occurrence of a fire according to a manual operation of a person who has discovered a fire and transmits the event data to the fire receiver 120_1.

Referring back to FIG. 1, each fire receiver is a device displaying a location of the fire based on the sensing data and event data received from the respective fire-fighting facilities and transmits an operation signal to a sound device or a broadcasting facility and a fire extinguishing facility at the same time to induce evacuation and fire extinguishing activities. Here, the location of the fire provided by each fire receiver is schematic information. For example, through the location of the fire, a person may know a floor on which the fire has occurred but cannot know in which area of the floor the fire has occurred.

In addition, each fire receiver configures the sensing data received through the detector (112 in FIG. 2) or the repeater 116 of the corresponding fire-fighting facility and the event data received from the transmitter (114 in FIG. 2) of the fire-fighting facility, as fire data and transmits the fire data to the disaster information management server 130. Here, the fire data may be transmitted to the disaster information management server 130 by a wired communication method or a wireless communication method.

In addition, each fire receiver may configure the fire data to further include event data related to a failure and abnormality of the fire-fighting facility in addition to the event data related to the occurrence of a fire received from the transmitter (114 in FIG. 2) and transmit the fire data to the disaster information management server 130. Here, not all the fire receivers 120_1 to 120_n may configure the fire data to include the event data related to a failure or abnormality of the fire-fighting facility. That is, some of the fire receivers 120_1 to 120_n may not provide event data related to a failure or abnormality of a fire-fighting facility.

In addition, the fire receivers 102_1 to 120_n are different receivers and configure the fire data in a data structure defined according to their respective communication protocols and transmit the fire data to the disaster information management server 130.

The disaster information management server 130 receives the fire data having different data structures received from the fire receivers 102_1 to 120_n, and converts the received fire data into standardized standard data.

In addition, the disaster information management server 130 maps the fire-fighting facility to spatial information (or boundary area ID) divided in advance to accurately identify a location of the fire.

Thereafter, the disaster information management server 130 is configured to include the spatial information mapped to the fire-fighting facility in the standardized standard data to generate final standard data, and transmits (or distributes) the generated final standard data to the server 200. Here, the external server 200 may be, for example, a server installed in a fire-related organization, and the relevant organization may be, for example, a 119 general situation room, a fire station, a police station, and the like.

In this manner, in order to convert the fire data having different data structures received from the fire receivers 120_1 to 120_n into standardized standard data and transmit the standard data to the external server 200, the disaster information management server 130 includes a data receiving module 132, a data management module 134, and a data transmitting module 136.

Hereinafter, the modules 132, 134, and 136 will be described in detail.

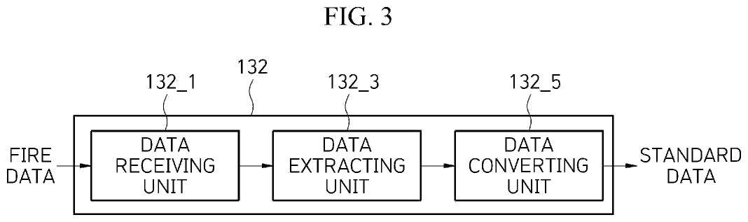

FIG. 3 is a block diagram of the data receiving module shown in FIG. 1.

Referring to FIG. 3, the data receiving module 132 includes a data receiving unit 132_1, a data extracting unit 132_3, and a data converting unit 132_5.

The data receiving unit 132_1 is a communication device for receiving fire data having different data structures according to different communication protocols (e.g., Modbus TCP) from different type fire receivers 120_1 to 120_n in a wired communication method or a wireless communication method.

The data extracting unit 132_3 parses the fire data transmitted through the data receiving unit 132_1, and extracts building identification data, fire-fighting facility identification data, sensing data, and event data from the fire data. The building identification data includes, for example, an identification code (building ID) of a building in which the fire-fighting facilities 110_1 to 110_n and the different types of fire receivers 120_1 to 120_n are installed. The fire-fighting facility identification data includes an identification code of the detector 112 and/or the transmitter 114 included in the fire-fighting facility. The sensed data includes a sensing value measured by the detector included in the fire-fighting facility. The sensing value includes, for example, a sensing value measured by a smoke detector, a sensing value measured by a heat detector, and the like. The event data includes an event code indicating a fire or gas occurrence and an event code indicating a failure or abnormality of a fire-fighting facility. The event code indicating the failure and abnormality of the fire-fighting facility may include a code indicating a power failure, a code indicating a line disconnection, a code indicating a stop of a fire shutter, and the like. Line disconnection refers to disconnection of a line connecting a fire receiver and a detector.

The data converting unit 132_5 converts the building identification data, fire-fighting facility identification data, sensing data, and event data extracted by the data extracting unit 132_3 into standardized standard data.

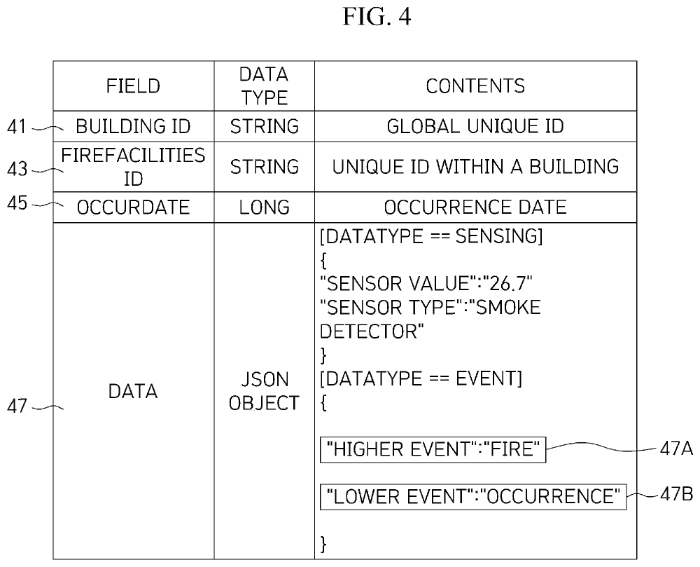

FIG. 4 is a diagram illustrating a data format of standard data converted from fire data received from different type fire receivers according to an embodiment of the present invention.

Referring to FIG. 4, a data format of the standard data converted from fire data received from different type fire receivers according to an embodiment of the present invention may be configured to include five fields.

Specifically, the data format of the standard data includes a first field 41 in which building identification information is recorded, a second field 43 in which fire-fighting facility identification information is recorded, a third field 45 in which data generation time is recorded, and a fourth field 47 in which data is recorded.

The data converting unit 132_5 generates standard data standardized in a manner of recording the data extracted from the fire data by the data extracting unit 132_3 according to a preset standard data mapping table in the first to fourth fields 41, 43, 45 and 47.

For example, the data converting unit 132_5 records the building identification data extracted from the fire data in the form of a string in the first field 41, records the fire-fighting facility identification data extracted from the fire data in the form of a string in the second field 43, and records a time or date of occurrence of the fire data (or a time or date of receiving the fire data from the fire receiver) in the form of a number (long) in the third field 45. In addition, the data converting unit 132_5 records the sensing data (e.g., sensor value, 26.7) and event data extracted from the fire data in the form of JSON (JavaScript Object Notation) in the fourth field 47.

The data format recorded in each field is not limited to string, number (long), and JSON (JavaScript Object Notation), and may be other data format.

Meanwhile, in an embodiment of the present invention, the event data extracted from the fire data by the data extracting unit 132_3 is classified as an upper event item 47A and a lower event item 47B standardized according to the mapping rule defined in the standard data mapping table and is recorded in the fourth field 47.

The upper event item 47A is an item in which an attribute of the event data extracted from the fire data is recorded, and the lower event item 47B is an item in which details corresponding to the attribute of the event data is recorded.

The attribute recorded in the upper event item 47A may be, for example, ‘fire’, ‘state abnormality alarm’, ‘facility operation alarm’, ‘other’, etc. Details recorded in the lower event item corresponding to ‘fire’ may include ‘occurrence/release’. The details recorded in the lower event items corresponding to the ‘state abnormality alarm’ may be, for example, ‘occurrence/release of private mode shutoff alarm’, ‘occurrence/release of commercial power alarm’, ‘occurrence/release of alarm valve operation input alarm’. The details recorded in the lower event items corresponding to the ‘facility operation alarm’ may include, for example, ‘occurrence/release of fire shutter detector input’, ‘occurrence/release of damper detector input alarm’, ‘occurrence/release of siren operation alarm’, etc. Details recorded in the lower event item corresponding to ‘other’ may include, for example, ‘gas occurrence/release’, ‘smoke occurrence/release, and ‘heat occurrence/release’.

It should be noted that among the upper event items 47A, ‘state abnormality alarm’ and ‘facility operation alarm’ are items indicating the presence or absence of a failure and abnormality of the fire-fighting facilities.

In an example, when event data related to ‘fire occurrence’ is included in the fire data received from the fire receiver, the data converting unit 132_5 classifies and maps the event data related to ‘fire occurrence’ as an upper event item indicating ‘fire’ and a lower event item indicating ‘occurrence/release’ according to the mapping rule defined in the standard data mapping table and records the same in the fourth field 47.

In another example, when event data related to ‘gas occurrence’ is included in the fire data received from another fire receiver, the data converting unit 132_5 classifies and maps the event data as an upper event item indicating ‘other’ and a lower event item indicating ‘gas occurrence/release’ according to the mapping rule defined in the standard data mapping table and records the same in the fourth field 47.

In another example, when event data related to ‘line disconnection’ is included in the fire data received from another fire receiver, the data converting unit 132_5 classifies and maps the event data as an upper event item indicating ‘state abnormality alarm’ and a lower event item indicating ‘occurrence/release of private mode shutoff alarm’ or ‘occurrence/release of alarm valve operation input alarm’ according to the mapping rule defined in the standard data mapping table and records the same in the fourth field 47.

In another example, when event data related to ‘power failure’ in is included in the fire data received from another fire receiver, the data converting unit 132_5 classifies and maps the event data as a lower event item indicating ‘commercial power supply alarm occurrence/release’ according to the mapping rule defined in the standard data mapping table and records the same in the fourth field 47.

As such, the present invention may be differentiated from the related art in that the standard data converted from fire data having different data structures is configured to include event data indicating the presence or absence of a failure and abnormality of fire-fighting facilities and transmitted to related organizations.

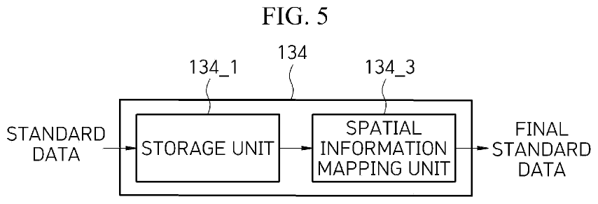

FIG. 5 is a block diagram of the data management module shown in FIG. 1.

Referring to FIG. 5, the data management module 134 includes a storage unit 134_1 storing standard data generated by the data receiving module 132 and spatial information mapping unit 134_3 generating final standard data generated by configuring spatial information mapped to a fire-fighting facility in the standard data.

The storage unit 134_1 may be a non-volatile storage medium for collecting and managing standard data generated by the data receiving module 132. Also, the storage unit 134_1 may further store the final standard data generated by the spatial information mapping unit 134_3 to collect and manage the final standard data.

The spatial information mapping unit 134_3 extracts spatial information mapped to the fire-fighting facility identification data included in the standard data from the mapping table with reference to the mapping table defining the mapping relationship between the fire-fighting facility and the spatial information and recording the extracted spatial information in the fourth field 47 of the standard data to generate final standard data.

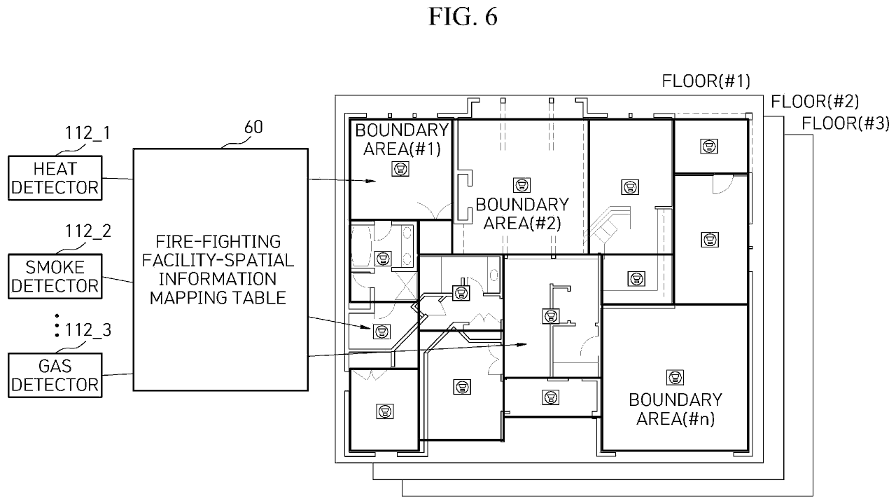

FIG. 6 is a diagram schematically illustrating a mapping table defining a mapping relationship between a fire-fighting facility and spatial information according to an embodiment of the present invention.

Referring to FIG. 6, when a detector of the fire-fighting facility includes a heat detector 112_1, a smoke detector 112_2, and a gas detector 112_3, the mapping table is configured to include spatial information mapped to identification information of the heat detector 112_1, spatial information mapped to identification information of the smoke detector 112_2, and spatial information mapped to identification information of the gas detector 112_3.

Spatial information includes, for example, building identification information (building ID), floor identification information (floor ID), and boundary area identification information (boundary area ID).

The building identification information includes a building identifier (building ID), and the floor identification information includes a floor identifier (floor ID). Also, the boundary area identification information includes boundary area identifiers of each of the plurality of boundary areas divided in each floor. The boundary area is an area previously demarcated based on a location where the heat detector is installed, a location where the smoke detector is installed, and a location where the gas detector is installed in each floor.

The spatial information mapping unit 134_3 extracts floor identification information (floor ID) and boundary area identification information (boundary area ID) mapped to fire-fighting facility information (e.g., identification information of the smoke detector, identification information of the gas detector, and identification information of the heat detector) included in the standard data generated by the data receiving module 132 or the data converting unit 132_5 by referring to the mapping table 60, and record the layer identification information (layer ID) extracted from the mapping table and the boundary area identification information (boundary area ID) in the fourth field 47 of the standard data to generate final standard data.

Floor identification information (floor ID) and the boundary area identification information (boundary area ID) may be recorded in, for example, an item in which sensor data is recorded in the fourth field 47, but is not limited thereto; and may be recorded in an item in which the standardized event data classified as an upper event item and a lower event item is recorded in the fourth field 47.

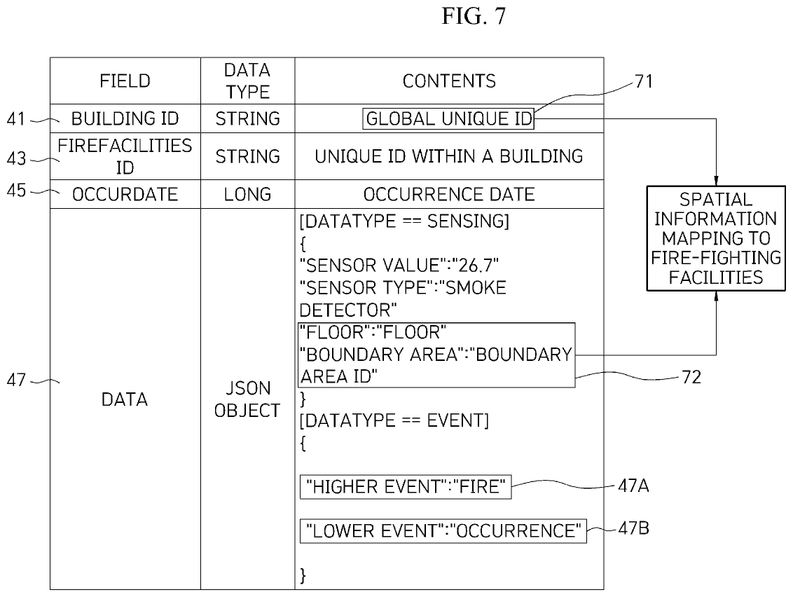

FIG. 7 shows a data format of the final standard data generated by the spatial information mapping unit 134_3 according to an embodiment of the present invention, and in FIG. 7, reference numerals 71 and 72 denote spatial information mapped to fire-fighting facility identification information included in the final standard data.

Referring back to FIG. 1, the data transmitting module 136 is a communication device for transmitting the final standard data generated by the data management module 134 or the spatial information mapping unit 134_3 of the data management module 134 to the external server 200 installed in a relevant organization according to a wired or wireless communication method. Since the present invention is not characterized by a hardware configuration of the data transmitting module, a description thereof is replaced with well-known known techniques.

In the disaster management system described above, the data receiving module 132 and the data management module 134 may be implemented as different computing devices, and may be integrated into one computing device. Here, the computing device may be basically a device implemented with a network interface, a hard disk, a memory, a processor (CPU), a graphic processor (GPU), a power supply, and a main board on which these are mounted. In this case, some or all functions of the data receiving module 132 and the data management module 134 may be hardware modules or software modules executed or controlled by the processor.

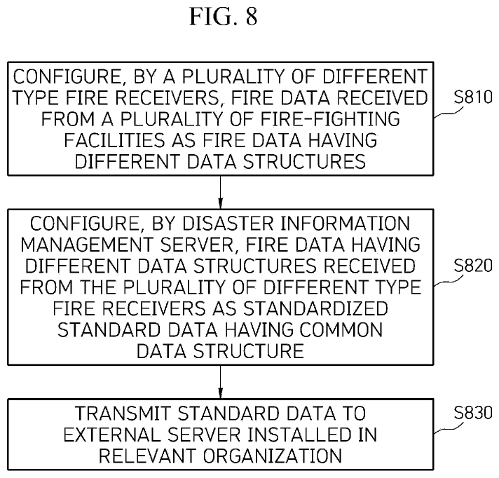

FIG. 8 is a flowchart illustrating a disaster information management method of a disaster management system according to an embodiment of the present invention.

Referring to FIG. 8, first, in operation S810, a plurality of different type fire receivers 120_1 to 120_n configure fire data received from a plurality of fire-fighting facilities 110_1 to 110_n as fire data having different data structures.

Next, in operation S820, the disaster information management server 130 configures the fire data having different data structures received from the plurality of different type fire receivers 120_1 to 120_n as standardized standard data having a common data structure.

Next, in operation S830, the disaster information management server 130 transmits the standard data to the external server 200 installed in the relevant organization.

In an embodiment, in the operation S810 of configuring the fire data having different data structures, the different type fire receivers may configure the fire data having different data structures according to respective different communication protocols.

In an embodiment, in operation S810 of configuring the fire data having different data structures, the fire data may be configured to include sensing data related to a fire, event data notifying an occurrence of a fire, event data related to a failure and abnormality of a fire-fighting facility, identification data of a building, and identification data of a fire-fighting facility.

In an embodiment, the common data structure of the standard data may include a first field 41 in which building identification information is recorded, a second field 43 in which fire-fighting facility identification information is recorded, a third field 45 in which a data generation time is recorded, and a fourth field 47 in which sensing data related to a fire extracted from the fire data and event data related to notification of a fire occurrence are recorded.

In an embodiment, the operation S820 of configuring the fire data having different data structures into standardized standard data having a common data structure may include a process of parsing the fire data to extract sensing data related to a fire, event data related to a fire occurrence notification and notification of failure and abnormality of a fire-fighting facility, identification data of a building, and identification data of a fire-fighting facility and a process of recording the identification data of the building in the field 41 defining building identification information, recording the identification data of the fire-fighting facility in the field 43 defining the fire-fighting facility identification information, and recording the sensing data and the event data in the field 47 defining the actual data to configure the standard data.

In an embodiment, the operation of configuring the standard data may be a process of classifying the event data as an upper event item 47A representing an attribute of the event data and a lower event item 47B representing details corresponding to the attribute of the event data, and recording the same in the field defining the actual data.

In an embodiment, the attribute of the event data may include an attribute related to a fire occurrence notification and an attribute related to a failure and abnormality notification of the fire-fighting facility.

In an embodiment, the operation S820 of configuring the fire data having different data structures into standardized standard data having a common data structure may include a process of parsing the fire data to extract sensing data related to the fire from the fire data, event data related to fire occurrence alarm and fire-fighting facility failure and abnormality notification and extracting the identification data of the building and the identification data of the fire-fighting facility, a process of recording the identification data of the building in a field defining the building identification information, recording the identification data of the fire-fighting facility in a field defining fire-fighting facility identification information, and recording the sensing data and the event data in a field defining actual data to configure first standard data, and a process of extracting spatial information mapped to fire-fighting facility identification data included in the first standard data from the mapping table by referring to the mapping table defining a mapping relationship between and fire-fighting facility and the spatial information and recording the extracted spatial information in the field defining the actual data of the first standard data to configure second standard data (or final standard data).

In an embodiment, the spatial information may include a floor identifier in a building and an identifier of a boundary area in which the fire-fighting facility is installed in each floor.

According to the present invention, fire-related data collected from different type fire receivers is converted into standardized data and the converted standardized data is configured to include an exact location of a fire and transmitted to a relevant organization, so that the relevant organization may integratedly manage fire-related disaster information, and may respond quickly and efficiently to a fire when a fire report is received.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A disaster information management method of a disaster management system, the disaster information management method comprising:
configuring, by a plurality of different type fire receivers, fire data received from a plurality of fire-fighting facilities to have different data structures;
configuring, by a disaster information management server, the fire data having different data structures received from the plurality of different fire receives, into standard data standardized to have a common data structure; and
transmitting, by the disaster information management server, the standard data to an external server installed in a relevant organization.

2. The disaster information management method of claim 1, wherein the configuring of the fire data having different data structures includes configuring the plurality of different type fire receivers to have fire data having the different data structures according to respective different communication protocols.

3. The disaster information management method of claim 1, wherein the configuring of the fire data having different data structures includes configuring the fire data to include sensing data related to fire, event data informing about an occurrence of fire, event data related to the presence or absence of failure and abnormality of a fire-fighting facility, identification data of a building, and identification data of the fire-fighting facility.

4. The disaster information management method of claim 1, wherein the common data structure of the standard data includes:
a first field in which identification information of a building is recorded;
a second field in which fire-fighting facility identification information is recorded;
a third field in which a data occurrence time is recorded; and
a fourth field in which sensing data related to a fire extracted from the fire data and event data related to fire occurrence notification are recorded.

5. The disaster information management method of claim 1, wherein the configuring of the fire data having different data structures into standardized standard data having a common data structure includes:
parsing the fire data to extract sensing data related to fire from the fire data, event data related to a notification of a fire occurrence and a notification of the presence or absence of failure or abnormality of a fire-fighting facility, and identification data of a building and identification data of the fire-fighting facility; and
configuring the standard data by recording the identification data of the building in a field defining building identification information, recording the identification data of the fire-fighting facility in a field defining fire-fighting facility identification information, and recording the sensing data and the event data in a field defining actual data.

6. The disaster information management method of claim 5, wherein the configuring of the standard data includes classifying the event data into a higher event item indicating an attribute of the event data and a lower event item indicating details corresponding to the attribute of the event data and recording the classified items in a field defining the actual data.

7. The disaster information management method of claim 6, wherein the attribute of the event data includes an attribute related to a fire occurrence notification and an attribute related to a notification of the presence or absence of a failure or abnormality of a fire-fighting facility.

8. The disaster information management method of claim 1, wherein the configuring of the fire data having different data structures into standardized standard data having a common data structure includes:
parsing the fire data to extract sensing data related to fire from the fire data, event data related to a notification of a fire occurrence and a notification of the presence or absence of failure or abnormality of a fire-fighting facility, and identification data of a building and identification data of the fire-fighting facility; and
configuring first standard data by recording the identification data of the building in a field defining building identification information, recording the identification data of the fire-fighting facility in a field defining fire-fighting facility identification information, and recording the sensing data and the event data in a field defining actual data; and
configuring second standard data by extracting spatial information mapped to fire-fighting facility identification data included in the first standard data from a mapping table by referring to the mapping table defining a mapping relation between the fire-fighting facility and spatial information and recording the extracted spatial information in a field defining the actual data of the first standard data.

9. The disaster information management method of claim 8, wherein the spatial information includes a floor identifier in a building and an identifier of a boundary area in which the fire-fighting facility are installed in each floor.

10. A disaster management system comprising:
a plurality of fire receivers configured to receive fire data including sensing data and event data from a plurality of fire-fighting facilities and configure the fire data as fire data having different data structures; and
a disaster information management server configured to configure the fire data having different data structures received from the plurality of fire receivers as standardized standard data and transmit the configured standard data to an external server.

11. The disaster management system of claim 10, wherein the disaster information management server includes:
a data receiving module configured to configure the fire data having different data structures received from the plurality of fire receivers as standardized standard data;
a data management module configured to generate final standard data by including spatial information mapped to identification data of a fire-fighting facility in the standard data; and
a data transmitting module configured to transmit the final standard data to the external server.

12. The disaster management system of claim 11, wherein the data receiving module includes:
a data receiving unit configured to receive the fire data having different data structures;
a data extracting unit configured to parse the fire data to extract sensing data related to fire from the fire data, event data related to a notification of a fire occurrence and a notification of the presence or absence of failure or abnormality of a fire-fighting facility, and identification data of a building and identification data of the fire-fighting facility; and
a data converting unit configured to convert the fire data into the standard data by recording the identification data of the building in a field defining building identification information, recording the identification data of the fire-fighting facility in a field defining fire-fighting facility identification information, and recording the sensing data and the event data in a field defining actual data.

13. The disaster management system of claim 11, wherein the data management module includes:
a storage unit configured to collect and manage the standard data; and
generating the final standard data by extracting spatial information mapped to fire-fighting facility identification data included in the standard data from a mapping table by referring to the mapping table defining a mapping relation between the fire-fighting facility and spatial information and including the extracted spatial information in the standard data.

14. The disaster management system of claim of 13, wherein the spatial information includes a floor identifier in a building and an identifier of a boundary area in which the fire-fighting facility is installed in each floor.

15. The disaster management system of claim 14, wherein, when the fire-fighting facility include a heat detector, a smoke detector, and a gas detector, the identifier of the boundary area includes an identifier of a boundary area in which the heat data is installed, an identifier of a boundary area in which the smoke detector is installed, and an identifier of a boundary area in which the gas detector is installed.
